(19) United States
(12) Patent Application Publication
(10) Pub. No.: US 2014/0227064 A1
(43) Pub. Date: Aug. 14, 2014

(54) BINDING APPARATUS AND IMAGE FORMING APPARATUS

(71) Applicants: Natsumi MATSUE, Kanagawa (JP); Koichi KUDO, Kanagawa (JP); Takashi HASHIMOTO, Kanagawa (JP); Tetsuo WATANABE, Kanagawa (JP); Fumihito MASUBUCHI, Kanagawa (JP); Takeshi OGAWA, Kanagawa (JP)

(72) Inventors: Natsumi MATSUE, Kanagawa (JP); Koichi KUDO, Kanagawa (JP); Takashi HASHIMOTO, Kanagawa (JP); Tetsuo WATANABE, Kanagawa (JP); Fumihito MASUBUCHI, Kanagawa (JP); Takeshi OGAWA, Kanagawa (JP)

(73) Assignee: Ricoh Company, Limited, Tokyo (JP)

(21) Appl. No.: 14/176,280

(22) Filed: Feb. 10, 2014

(30) Foreign Application Priority Data
Feb. 12, 2013 (JP) 2013-024178

(51) Int. Cl. B42C 1/12; B42C 13/00

(52) U.S. Cl. CPC B42C 1/12; B42C 13/00
USPC 412/37; 412/33

(57) ABSTRACT

A binding apparatus includes: an accumulating unit where a plurality of sheets having an area that serves as a binding margin is to be stacked as a sheet bundle, in which toner is fixed onto all of, or a part of, the area; a pressure unit that sandwiches the binding margin of the sheet bundle stacked on the accumulating unit therebetween and applies a pressure to the binding margin; and a heating unit that heats the toner on the binding margin that is receiving the pressure applied by the pressure unit. The pressure unit is configured to apply the pressure to the binding margin while forming a plurality of grooves and ridges in the binding margin in a direction in which the pressure is applied.

### CROSS-REFERENCE TO RELATED APPLICATIONS

The present application claims priority to and incorporates by reference the entire contents of Japanese Patent Application No. 2013-024178 filed in Japan on Feb. 12, 2013.

### BACKGROUND OF THE INVENTION

1. Field of the Invention

The present invention relates to a binding apparatus and an image forming apparatus.

2. Description of the Related Art

Conventionally, a binding apparatus that is mounted on or beside an image forming apparatus, such as a copying machine or a printing machine, and that binds a plurality of sheets by using toner as an adhesive is known. The binding apparatus binds a sheet bundle of a plurality of sheets by applying heat and pressure to a portion, which serves as a binding margin and onto which toner is fixed, of the sheets. An example of such a binding apparatus is disclosed in Japanese Laid-open Patent Application No. 2004-209859.

Japanese Laid-open Patent Application No. 2004-209859 discloses a technique related to such a binding apparatus that performs binding using toner. The technique adjusts a period of time, over which the binding margin is pressed, a period of time, over which the binding margin is heated, and a heating temperature depending on a thickness of the sheet bundle to prevent uneven adhesion between the sheets that are adhered together with the toner.

Meanwhile, a binding apparatus that performs binding without using a metal staple is disclosed in Japanese Laid-open Patent Application No. 2010-208854, for example. The binding apparatus performs binding by pressing a portion, which serves as a binding margin, of a sheet bundle of a plurality of sheets with a toothed member, thereby forming grooves and ridges in the binding margin in a thickness direction and bringing the sheets into mesh with each other.

However, conventional binding apparatuses that perform binding using toner have encountered difficulty in adhering sheets of a sheet bundle together with toner evenly, firmly, and efficiently.

For example, because the binding apparatus disclosed in Japanese Laid-open Patent Application No. 2004-209859 adjusts the period of time, over which the binding margin is pressed, the period of time, over which the binding margin is heated, and the heating temperature depending on the thickness of the sheet bundle, a detecting unit and a control unit of the binding apparatus are disadvantageously complicated.

Therefore, it is desirable to provide a binding apparatus capable of, even when the apparatus binds a sheet bundle using toner, adhering sheets of the sheet bundle together with the toner evenly, firmly, and efficiently, and an image forming apparatus including the binding apparatus.

### SUMMARY OF THE INVENTION

It is an object of the present invention to at least partially solve the problems in the conventional technology.

According to an aspect of the present invention, there is provided a binding apparatus that binds a sheet bundle, the binding apparatus including: an accumulating unit where a plurality of sheets having an area that serves as a binding margin is to be accumulated as the sheet bundle, in which toner is fixed onto all of, or a part of, the area; a pressure unit that sandwiches the binding margin of the sheet bundle stacked on the accumulating unit therebetween and applies a pressure to the binding margin; and a heating unit that heats the toner on the binding margin that is receiving the pressure applied by the pressure unit, wherein the pressure unit is configured to apply the pressure to the binding margin while forming a plurality of grooves and ridges in the binding margin in a direction in which the pressure is applied.

According to another aspect of the present invention, there is provided an image forming apparatus including a binding apparatus that binds a sheet bundle, the binding apparatus including: an accumulating unit where a plurality of sheets having an area that serves as a binding margin is to be accumulated as the sheet bundle, in which toner is fixed onto all of, or a part of, the area; a pressure unit that sandwiches the binding margin of the sheet bundle stacked on the accumulating unit therebetween and applies a pressure to the binding margin; and a heating unit that heats the toner on the binding margin that is receiving the pressure applied by the pressure unit, wherein the pressure unit is configured to apply the pressure to the binding margin while forming a plurality of grooves and ridges in the binding margin in a direction in which the pressure is applied.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an overall configuration diagram illustrating an image forming apparatus according to an embodiment;

FIG. 2 is a configuration diagram illustrating a relevant portion of a binding apparatus;

FIGS. 3A to 3D are schematic diagrams each illustrating a state where a sheet bundle is pressed and heated in the binding apparatus;

FIG. 4 is a timing diagram illustrating control performed in the binding apparatus;

FIG. 5 is a configuration diagram illustrating a relevant portion of a first modification of the binding apparatus;

FIGS. 6A to 6C are configuration diagrams illustrating a relevant portion of a second modification of the binding apparatus; and

FIG. 7 is a configuration diagram illustrating a relevant portion of a third modification of the binding apparatus.

### DETAILED DESCRIPTION OF THE PREFERRED EMBODIMENTS

An exemplary embodiment is described below with reference to the accompanying drawings. Like reference numerals and/or symbols identify identical or corresponding elements and portions in the drawings, and repeated description is simplified or omitted.

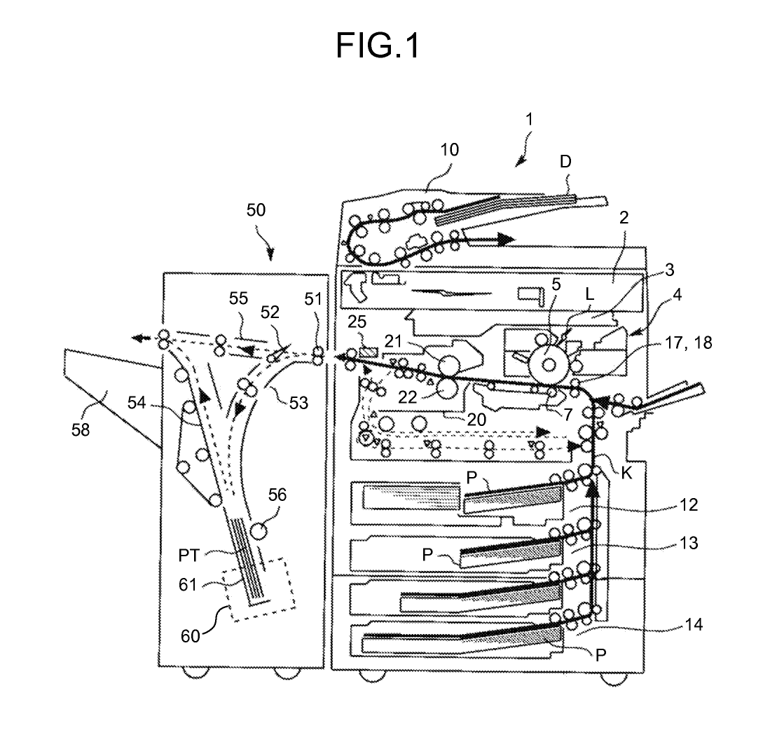

An overall configuration and operations of an image forming apparatus according to an embodiment is described below with reference to FIG. 1.

Referring to FIG. 1, a copying machine, which is the image forming apparatus, includes an apparatus body (image forming apparatus body) 1, a document reading unit 2 that obtains image data by optically reading an original document (hereinafter, “document”) D, an exposing unit 3 that emits exposure light L onto a photosensitive element 5 based on the image data read by the document reading unit 2, an image forming station 4 that forms a toner image (image) on the photosensitive element 5, a transfer unit (image forming unit) 7 that transfers the toner image formed on the photosensitive element 5 onto a media sheet (sheet) P, a document conveying unit 10 that conveys the document D, which is loaded on the document conveying unit 10, to the document reading unit 2, sheet feeding units 12 to 14 containing therein the sheets P of transfer paper or the like, registration rollers (timing rollers) 17 and 18 that convey the sheet P toward the transfer unit 7, a fixing device 20 that fixes a not-yet-fixed image on the sheet P, a fixing roller 21 mounted in the fixing device 20, a pressure roller 22 mounted in the fixing device 20, and a cooling device 25 that cools the sheet P after a fixing step.

A binding apparatus 50 is a postprocessing apparatus that binds a sheet bundle PT, which is a bundle the sheets P conveyed from the image forming apparatus body 1 via an entry unit 51. The sheet P or the sheet bundle PT is ejected to and stacked on a sheet ejecting unit (stacker unit) 58. The binding apparatus 50 is mounted on or beside the image forming apparatus body 1 to be detachable therefrom.

How the image forming apparatus body 1 operates during normal image forming is described below with reference to FIG. 1.

First, the document D is conveyed by conveying rollers of the document conveying unit 10 from a document table in a direction indicated by an arrow in FIG. 1 and passes above the document reading unit 2. At this time, the document reading unit 2 obtains image data by optically reading the document D passing above the document reading unit 2.

The optical image data read by the document reading unit 2 is converted into electrical signals and thereafter transmitted to the exposing unit 3 (writing unit). The exposing unit 3 emits the exposure light L, e.g., laser light, toward the photosensitive element 5 of the image forming station 4 based on the image data of the electrical signals.

Meanwhile, the photosensitive element 5 of the image forming station 4 is rotating clockwise in FIG. 1. An image (toner image) according to the image data is formed on the photosensitive element 5 through a predetermined image forming process (an electrostatic charging step, an exposing step, and a developing step).

Thereafter, the image formed on the photosensitive element 5 is transferred onto the sheet P conveyed by the registration rollers 17 and 18 in the transfer unit 7, which is the image forming unit.

Meanwhile, the sheet P is conveyed to the transfer unit 7 (image forming unit) in the following manner.

One sheet feeding unit of the plurality of sheet feeding units 12, 13, and 14 of the image forming apparatus body 1 is manually or automatically selected (in this example, it is assumed that the uppermost sheet feeding unit 12 is selected).

An uppermost one of the sheets P stored in the sheet feeding unit 12 is conveyed toward a conveyance path K.

Thereafter, the sheet P passes through the conveyance path K, on which a plurality of conveying rollers are arranged, and arrives at the registration rollers 17 and 18. The sheet P arrived at the registration rollers 17 and 18 is then conveyed toward the transfer unit 7 (image forming unit) with timing adjusted for registration with the image formed on the photosensitive element 5.

The sheet P undergone a transfer step passes by the transfer unit 7 and thereafter arrives at the fixing device 20 through a conveyance path. The sheet P arrived at the fixing device 20 is delivered into a nip between the fixing roller 21 and the pressure roller 22, at which the image is fixed by heat applied from the fixing roller 21 and a pressure applied from both the pressure roller 22 and the fixing roller 21. The sheet P, onto which the image is fixed, is delivered out from the nip between the fixing roller 21 and the pressure roller 22 and then cooled by the cooling device 25, by which the image is fixed more firmly. Thereafter, the sheet P is ejected from the image forming apparatus body 1.

The sheet P ejected from the image forming apparatus body 1 is further conveyed (delivered) into the binding apparatus 50 via the entry unit 51.

When “NORMAL MODE” is selected by a user in advance from an operation panel (not shown) of the apparatus body 1, a bifurcating claw 52 performs conveyance path switching so that the sheet P is directly ejected to the sheet ejecting unit 58 via a straight conveyance path 55.

On the other hand, when “BINDING MODE” is selected by a user in advance from the operation panel of the apparatus body 1, the bifurcating claw 52 performs conveyance path switching so that the sheet P is conveyed toward an accumulating unit 61 (processing unit) via a processing conveyance path 53. When a plurality of the sheets P has been stacked in the accumulating unit 61 and the desired sheet bundle PT has been formed, the sheet bundle PT is aligned in a width direction and in a conveying direction by movements of jogger fences (not shown). Thereafter, a binding unit 60 binds the sheet bundle PT. Thereafter, the bound sheet bundle PT is conveyed by a conveying roller 56 and a conveying belt 54 to be ejected onto the sheet ejecting unit 58.

The binding apparatus 50 (the binding unit 60) according to the embodiment is configured to bind the sheet bundle PT by using adhesiveness of toner rather than using a metal staple.

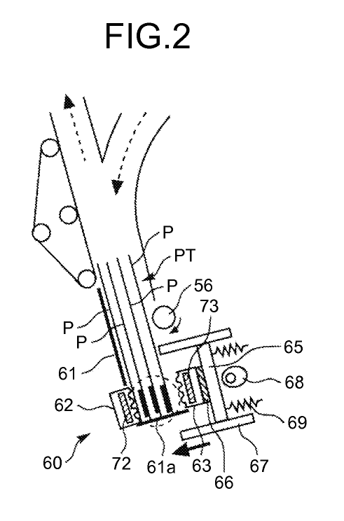

More specifically, referring to FIG. 2, the binding unit 60 of the binding apparatus 50 includes the accumulating unit 61 (accumulating tray) where the plurality of sheets P is to be stacked as the sheet bundle PT. Toner is fixed to an area (indicated by a dotted circle in FIG. 2), which serves as a binding margin, of the sheets P on the accumulating unit 61. As described earlier, the sheets P, on each of which an image is formed through an image forming step in the image forming station 4 and the fixing step in the fixing device 20 of the image forming apparatus body 1, are conveyed to the binding apparatus 50 and stacked one sheet by one sheet on the accumulating unit 61 in a state where a leading end portion (on a side of the binding margin) of the sheet P abuts on an abutting portion 61a. Note that, in addition to a toner image formed based on image data, toner (toner T for use as an adhesive) for adhering the sheets P together is fixed onto the leading end portion (serving as the binding margin) of the sheet P stacked on the accumulating unit 61. The adhesive toner T is formed through the image forming step in the image forming station 4 and the fixing step in the fixing device 20 of the image forming apparatus body 1 as is the toner image formed based on image data. In the embodiment, a swath of a toner image (e.g., a solid image) extending in the width direction (which is the direction orthogonal to the paper plane of FIG. 2) is formed in the leading end portion of a surface of each of the plurality of sheets P, excluding the sheet P that is stacked on the accumulating unit 61 first, that make up the sheet bundle PT. This toner image acts as an adhesive that adheres (binds) the sheets P together.

The binding unit 60 includes a pressure unit (62, 63, and 65 to 69) and heating unit (heat source 72 and 73). The pressure unit includes a receiving unit 62, a pressing unit 63, a movable plate 65, an elastic member 66, a guide rail 67, an eccentric cam 68, and an extension spring 69. The heating unit includes a ceramic heater 72 and a ceramic heater 73. The pressure unit sandwiches and applies a pressure to the binding margin (the portion indicated by the dotted circle in FIG. 2) of the sheet bundle PT stacked on the accumulating unit 61. The heating unit heats toner on the binding margin of the sheet bundle PT that is receiving the pressure applied by the pressure unit.

The toner T that is fused by heat applied by the heating unit undergoes the pressures applied by the pressure unit and thereafter natural cooling, thereby adhering (binding) the sheets P together.

The receiving unit 62 (fixed unit) is fixed to a bottom side of the accumulating unit 61 in a manner to face the binding margin of the sheet bundle PT placed on the accumulating unit 61.

The pressing unit 63 (movable unit) is disposed on a ceiling side of the accumulating unit 61 in a manner to face the receiving unit 62 across the binding margin of the sheet bundle PT placed on the accumulating unit 61. The pressing unit 63 is configured to be relatively movable toward or away from the receiving unit 62. The pressing unit 63 is fixed onto the movable plate 65 via the elastic member 66 having heat resistance. The movable plate 65 is configured to be slidable on the guide rail 67 in a direction (pressing direction indicated by an arrow in FIG. 2) toward the receiving unit 62 and a direction (non-pressing direction) away from the receiving unit 62. The extension spring 69 that urges the movable plate 65 in the direction away from the receiving unit 62 (the sheet bundle PT) is connected to the movable plate 65. When the eccentric cam 68 is not in mesh, the urging force of the extension spring 69 holds the movable plate 65 at a stopper portion (not shown; formed on the guide rail 67) that is sufficiently away from the receiving unit 62 (the sheet bundle PT). However, when the eccentric cam 68 is rotated by a driving motor (not shown) about a rotating shaft, the movable plate 65 is pushed by the eccentric cam 68 toward the receiving unit 62 against the urging force of the extension spring 69. As a result, the movable plate 65 sandwiches and presses the binding margin of the sheet bundle PT between the movable plate 65 and the receiving unit 62.

Because the pressing unit 63 and the receiving unit 62 sandwich and press the binding margin of the sheet bundle PT therebetween, they are preferably made of a rigid material, such as a metal material. The elastic member 66 is for use in adjusting a pressing force to be applied to the binding margin of the sheet bundle PT sandwiched between the pressing unit 63 and the receiving unit 62, and made of an elastic material such as a rubber material.

The heating unit is configured to heat each of the receiving unit 62 and the pressing unit 63. More specifically, the heating unit includes the ceramic heater 72 built in the receiving unit 62 and the ceramic heater 73 built in the pressing unit 63. Electrical power is supplied from a power source (not shown) to each of the heaters 72 and 73 to heat the receiving unit 62 and the pressing unit 63. The receiving unit 62 and the pressing unit 63 heat the binding margin of the sheet bundle PT that is being sandwiched and pressed between the receiving unit 62 and the pressing unit 63. As a result, the toner is heated and fused, and binding is performed.

The receiving unit 62 and the pressing unit 63 are heated by heat conducted from the ceramic heaters 72 and 73 serving as the heat source. Accordingly, the receiving unit 62 and the pressing unit 63 are preferably made of a high-thermal-conductivity material, such as a metal material. In the embodiment, the ceramic heaters are used as the heating unit (the heat source). However, other heat source, such as resistance heating elements, halogen heaters, or electromagnetic induction coils, can alternatively be used as the heating unit. The ceramic heaters 72 and 73 are controlled so as to heat the receiving unit 62 and the pressing unit 63 to a temperature equal to or higher than a melting point of the toner T.

Characteristic configuration and operations of the binding apparatus 50 (the binding unit 60) according to the embodiment are described in detail below.

In the embodiment, the pressure unit of the binding apparatus 50 is configured to press the binding margin of the sheet bundle PT placed on the accumulating unit 61 while forming a plurality of grooves and ridges on the binding margin in the pressing direction.

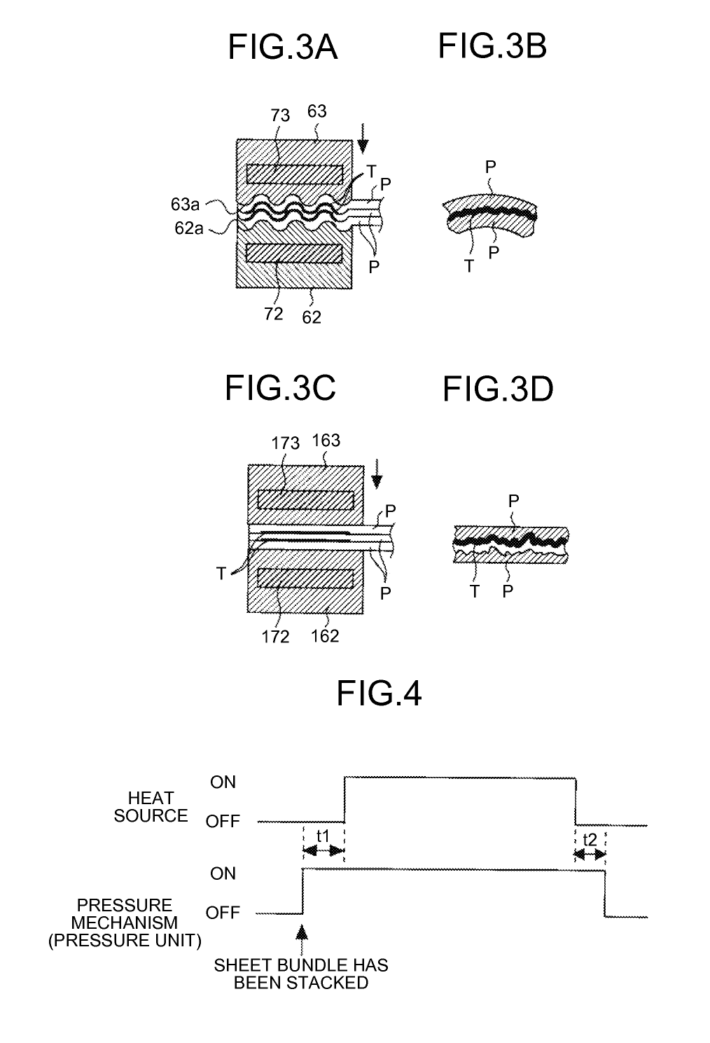

More specifically, referring to FIG. 3A, the receiving unit 62 has a plurality of grooves and ridges on an opposing surface 73a that faces the binding margin of the sheet P. The pressing unit 63 has, on an opposing surface 63a, a plurality of grooves and ridges formed so as to engage with the plurality of grooves and ridges formed on the opposing surface 62a of the receiving unit 62.

In the embodiment, the plurality of grooves and ridges formed on the opposing surface 62a of the receiving unit 62 and the opposing surface 63a of the pressing unit 63 have a regular, wave-like pattern in the conveying direction (the direction perpendicular to the width direction) of the sheets P. In the embodiment, the grooves are at intervals of approximately 1 to 2 millimeters; a distance, or height, (depth) between crests of the ridges and bottoms of the grooves is approximately 0.4 to 1 millimeter.

The above configuration brings, even when the surface of each of the sheets P that make up the sheet bundle PT has minute grooves and ridges, the binding margin of the sheet bundle PT pressed between the receiving unit 62 and the pressing unit 63 into close contact while deforming the binding margin in a manner to take the shape of the grooves and ridges of the receiving unit 62 and the pressing unit 63 as illustrated in FIG. 3A. From a macroscopic view, as illustrated in FIG. 3B, the toner T permeates through the minute grooves and ridges (grooves and ridges formed between fibers of paper) formed on the surface of the sheet P. Because the toner T is interposed between the sheets P with little voids, efficiency in heating the toner T is increased, causing the sheets P to be adhered (bound) together firmly. In addition, the grooves and ridges formed on the receiving unit 62 and the pressing unit 63 increase an area that heats the binding margin. As a result, the efficiency in heating the toner T on the binding margin is further increased.

FIG. 3C illustrates a configuration in which each of a receiving unit 162 (including a built-in heater 172) and a pressing unit 163 (including a built-in heater 173) does not have grooves and ridges but has a flat opposing surface. From a macroscopic view, as illustrated in FIG. 3D, in this configuration, the toner T does not permeate through the minute grooves and ridges formed on the surface of the sheet P, and voids are undesirably created between the sheets P. Accordingly, efficiency in heating the toner T is decreased, and the sheets P are adhered (bound) together less firmly, which are disadvantageous.

The advantage described above of the present embodiment is particularly remarkably advantageous when sheets having rough and irregular grooves and ridges (grains) on their surfaces as does recycled paper are used as the sheets P that make up the sheet bundle PT.

In the embodiment, the grooves and ridges formed on the receiving unit 62 and the pressing unit 63 have the regular, wave-like pattern in the conveying direction of the sheet P. However, the grooves and ridges of the receiving unit 62 and the pressing unit 63 are not limited to those of the embodiment. For instance, the grooves and ridges may be formed in a direction corresponding to the width direction of the sheet P or, alternatively, may be formed to have a matrix-like pattern in directions corresponding to the width direction and the conveying direction of the sheet P. The grooves and ridges may be formed to have, for instance, a substantially needle shape, in which distal ends of the ridges are pointed.

In the embodiment, as illustrated in FIG. 4, the heating unit starts heating the toner T on the binding margin time t1 later than when the pressure unit (pressure mechanism) starts applying a pressure to the binding margin. This control allows the binding margin to be heated efficiently without supplying needless electrical power to the heating unit. Meanwhile, a similar effect to that described above can be obtained when the heating unit starts heating the binding margin simultaneously when the pressure unit (pressure mechanism) starts applying the pressure to the toner T on the binding margin.

Furthermore, in the embodiment, the heating unit stops heating the toner T on the binding margin time t2 earlier than when the pressure unit (pressure mechanism) stops applying the pressure to the binding margin. This control allows reserving time, over which the toner T on the binding margin receives the pressure from the pressure unit while undergoing natural cooling, after the heating unit stops heating. As a result, the binding margin can be adhered firmly.

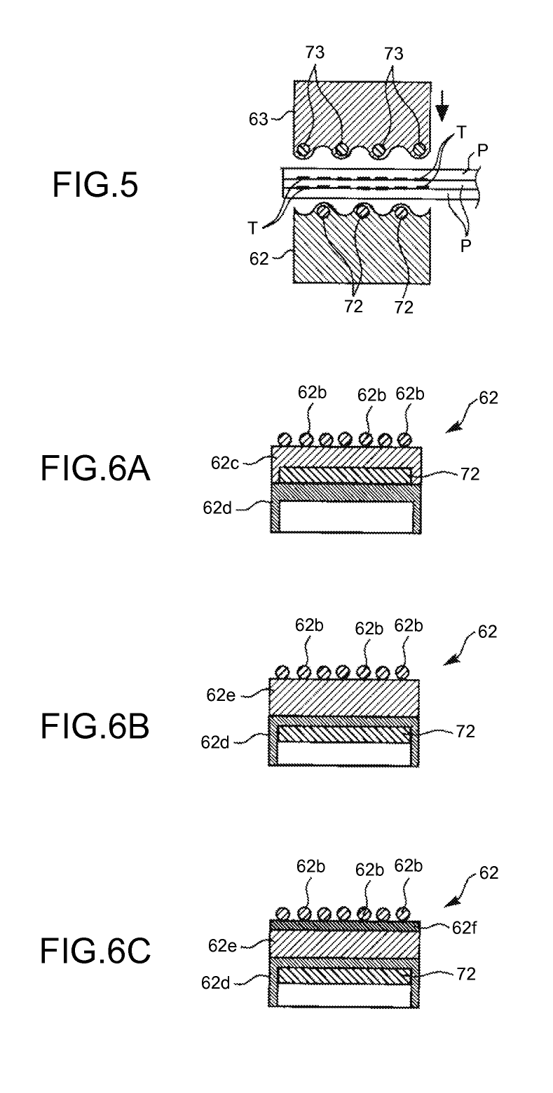

FIG. 5 is a configuration diagram illustrating a relevant portion of a first modification of the binding apparatus 50 according to the embodiment.

A configuration illustrated in FIG. 5 employs, as the heating unit, the heat source 72 and the heat source 73 that are buried at positions corresponding to distal ends of the ridges of the receiving unit 62 and positions corresponding to distal ends of the ridges of the pressing unit 63, respectively. More specifically, the heat source includes the heating wires 72 (wire heaters) buried in the distal ends of the ridges of the receiving unit 62 and the heating wires 73 (wire heaters) buried in the distal ends of the ridges of the pressing unit 63. The heat source is made of an alloy material such as a nickel-chromium alloy or a ferrochrome alloy. This configuration causes heat from the heat source 72 and 73 to be concentrated to portions of the binding margin that are brought into close contact by engagement between the receiving unit 62 and the pressing unit 63. Accordingly, the efficiency in heating the toner T on the binding margin is further increased.

In the configuration illustrated in FIG. 5, the toner T is fixed to the sheets P stacked on the accumulating unit 61 at positions corresponding to the distal ends of the ridges of the receiving unit 62 and positions corresponding to the distal ends of the ridges of the pressing unit 63. More specifically, in the image forming step in the image forming station 4 described above, a discontinuous solid image is formed at portions, which correspond to the positions where the heating wires 72 and 73 are arranged, of an area of the binding margin of the sheet P instead of forming a solid image across a substantially entire area of the binding margin of the sheet P. As a result, efficient binding can be performed by reducing an amount of toner consumed to form the binding margin in the image forming step.

FIGS. 6A to 6C are configuration diagrams illustrating a relevant portion of a second modification of the binding apparatus 50 according to the embodiment.

In a configuration illustrated in FIG. 6A, the grooves and ridges of the receiving unit 62 are formed by fixing (adhering) a plurality of granular members 62b onto a surface of a ceramic layer 62c formed on a substrate 62d. The granular members 62b are made of a hard, high-thermal-conductivity material of which grain diameter is approximately 50 micrometers and arranged at intervals greater than the grain diameter. This configuration allows, even when the grooves and ridges on an opposing surface, which faces the sheet bundle PT, of the pressing unit 63 are formed less accurately and therefore the opposing surface is almost flat, bringing the binding margin of the sheet bundle PT into close contact with the opposing surfaces of the pressing unit 63 and the receiving unit 62. Accordingly, an effect similar to that provided by the embodiment can be obtained.

In a configuration illustrated in FIG. 6B, the grooves and ridges of the receiving unit 62 are formed by fixing the plurality of granular members 62b onto a surface of a heat-resistant elastic layer 62e formed on the substrate 62d. This configuration provides, in addition to the effect described above, an effect of preventing a pressing force applied onto the sheet bundle PT between the receiving unit 62 and the pressing unit 63 from increasing excessively high.

In a configuration illustrated in FIG. 6C, the grooves and ridges of the receiving unit 62 are formed by fixing the plurality of granular members 62b with an intermediate layer (or film) 62f therebetween onto the surface of heat-resistant elastic layer 62e formed on the substrate 62d. The intermediate layer 62f is made of a heat-resistant material of high hardness. This configuration provides, in addition to the effects described above, an effect of preventing the plurality of granular members 62b from being disadvantageously buried in the heat-resistant elastic layer 62e when the sheet bundle PT is pressed between the receiving unit 62 and the pressing unit 63.

In the binding apparatus 50 configured as described above, a balance between an amount of heat from the ceramic heaters 72 arranged in the receiving unit 62 and an amount of heat from the ceramic heaters 73 arranged in the pressing unit 63 may be changed. For instance, in a situation where the binding margin receives a higher amount of heat on a side facing the receiving unit 62 than that received on a side facing the pressing unit 63, an amount of heat applied from the ceramic heaters 72 arranged in the receiving unit 62 can be set to be lower than an amount of heat applied from the ceramic heaters 73 arranged in the pressing unit 63, so that heat is applied evenly across the entire binding margin.

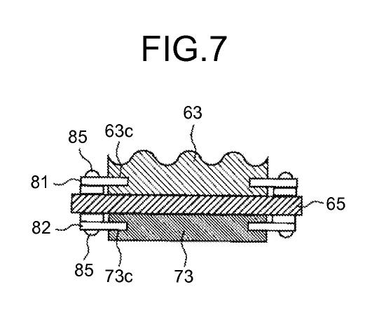

FIG. 7 is a configuration diagram illustrating a relevant portion of a third modification of the binding apparatus 50 according to the embodiment.

In a configuration illustrated in FIG. 7, the pressing unit 63 and the ceramic heater 73 (heat source) are configured to be independently detachable (replaceable) from the movable plate 65. More specifically, the pressing unit 63 is detachably mounted on the movable plate 65 as follows. A plate member 81 is fit in a groove 63c defined in a side portion of the pressing unit 63 and fixed onto the movable plate 65 by being fastened with a screw 85. Similarly, the ceramic heater 73 is detachably mounted on the movable plate 65 as follows. A plate member 82 is fit in a groove 73c defined in a side portion of the ceramic heater 73 and fixed onto the movable plate 65 by being fastened with the screw 85. This configuration allows performing maintenance of the pressing unit 63 and the ceramic heater 73 separately that presumably differ from each other in maintenance cycle and need maintenance at different times. Furthermore, this configuration allows changing a structure of the pressure unit easily in a situation where, for example, it is desired not to use the ceramic heater 73 but to mount a pressing unit (attachment) of another form having a substantially comblike opposing surface that faces the binding margin. In such a situation, there can be employed a configuration that allows a user to select a mode for performing binding without forming a toner image in the binding margin by operating the operation panel.

Although only the configuration of the pressing unit 63 is illustrated in FIG. 7, the receiving unit 62 may be similarly configured such that the receiving unit 62 and the ceramic heater 72 are detachable.

As described above, in the embodiment, even when binding is performed using the toner T, a plurality of grooves and ridges are formed in a binding margin by the pressure unit (62, 63, and 65 to 69); and, in this state, the toner T on the binding margin is heated by the heating unit (72 and 73). Accordingly, binding can be performed by adhering the sheets P of the sheet bundle PT together with the toner T evenly, firmly, and efficiently.

In the embodiment, the present invention is applied to the binding apparatus 50 mounted on or beside the monochrome image forming apparatus. However, as a matter of course, the present invention is also applicable to a binding apparatus mounted on or beside a color image forming apparatus.

In the embodiment, the present invention is applied to the binding apparatus 50 mounted on or beside the electrophotographic image forming apparatus. However, as a matter of course, the present invention is not limited thereto and also applicable to a binding apparatus mounted on or beside an image forming apparatus of other type (e.g., an inkjet image forming apparatus).

Moreover, the present invention is also applicable to an independent binding apparatus, rather than the binding apparatus 50 connected to the image forming apparatus. Examples of the independent binding apparatus include a binding apparatus including a conveyance port where a sheet feeding cassette is to be placed and an operation panel from which a processing mode and the like are to be entered.

Each of these configurations can provide an effect(s) similar to that (those) provided by the embodiment.

As described above, according to an aspect of the present embodiment, there is provided a binding apparatus that, even when the apparatus performs binding using toner, binds a sheet bundle by adhering sheets of the sheet bundle together with the toner evenly, firmly, and efficiently, and an image forming apparatus including the binding apparatus. This is achieved by causing a pressure unit to form a plurality of grooves and ridges in a binding margin of the sheet bundle and causing a heating unit to heat toner on the binding margin that is being pressed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A binding apparatus that binds a sheet bundle, the binding apparatus comprising:
an accumulating unit where a plurality of sheets having an area that serves as a binding margin is to be accumulated as the sheet bundle, in which toner is fixed onto all of, or a part of, the area;
a pressure unit that sandwiches the binding margin of the sheet bundle stacked on the accumulating unit therebetween and applies a pressure to the binding margin; and
a heating unit that heats the toner on the binding margin that is receiving the pressure applied by the pressure unit, wherein
the pressure unit is configured to apply the pressure to the binding margin while forming a plurality of grooves and ridges in the binding margin in a direction in which the pressure is applied.

2. The binding apparatus according to claim 1, wherein
the pressure unit comprises:
a receiving unit having an opposing surface on which a plurality of grooves and ridges are formed, the opposing surface facing the binding margin; and
a pressing unit having an opposing surface, on which a plurality of grooves and ridges are formed so as to engage with the plurality of grooves and ridges of the receiving unit, and being relatively movable toward and away from the receiving unit, and
the heating unit is configured to heat each of the receiving unit and the pressing unit.

3. The binding apparatus according to claim 2, wherein the heating unit includes a heat source buried at a position corresponding to distal ends of the ridges of the receiving unit and a heat source buried at a position corresponding to distal ends of the ridges of the pressing unit.

4. The binding apparatus according to claim 3, wherein the toner is fixed onto a first position and a second position in the area serving as the binding margin of the sheets stacked on the accumulating unit, the first position corresponding to the distal ends of the ridges of the receiving unit, the second position corresponding to the distal ends of the ridges of the pressing unit.

5. The binding apparatus according to claim 1, wherein the heating unit starts heating the toner on the binding margin simultaneously or later than when the pressure unit starts applying the pressure to the binding margin.

6. The binding apparatus according to claim 1, wherein the heating unit stops heating the binding margin earlier than when the pressure unit stops applying the pressure to the binding margin.

7. An image forming apparatus comprising a binding apparatus that binds a sheet bundle, the binding apparatus comprising:
an accumulating unit where a plurality of sheets having an area that serves as a binding margin is to be accumulated as the sheet bundle, in which toner is fixed onto all of, or a part of, the area;
a pressure unit that sandwiches the binding margin of the sheet bundle stacked on the accumulating unit therebetween and applies a pressure to the binding margin; and
a heating unit that heats the toner on the binding margin that is receiving the pressure applied by the pressure unit, wherein
the pressure unit is configured to apply the pressure to the binding margin while forming a plurality of grooves and ridges in the binding margin in a direction in which the pressure is applied.
